(19) United States
(12) Patent Application Publication
(10) Pub. No.: US 2017/0028668 A1
(43) Pub. Date: Feb. 2, 2017

(54) Polymeric Multilayer Film

(71) Applicant: Buergofol GmbH, Siegenburg, OT (DE)

(72) Inventors: Abdel-Kader Boutrid, Siegenburg (DE); Kurt Stark, Neuhaus (DE); Franz Schleicher, Ingolstadt (DE)

(21) Appl. No.: 15/302,881

(22) PCT Filed: Apr. 8, 2015
(86) PCT No.: PCT/EP2015/057643

§ 371 Date: Oct. 7, 2016

(30) Foreign Application Priority Data
Apr. 9, 2014 (DE) 102014105085.1

(51) Int. Cl. B32B 1/08; F16L 55/165; B32B 27/32; B32B 27/30; B32B 27/08; B32B 27/34

(52) U.S. Cl. CPC B32B 1/08; B32B 27/08; B32B 27/34; B32B 27/32; B32B 27/306; F16L 55/1656; B32B 2307/414; B32B 2307/7242; B32B 2597/00; B32B 2307/546

(57) ABSTRACT

A polymeric multilayer film having at least one polyamide layer as well as at least one further layer of a different polymeric material, the multilayer film having high elasticity and good flexibility.

This application is a United States National Stage Application claiming the benefit of priority under 35 U.S.C. 371 from International Patent Application No. PCT/EP2015/057643 filed Apr. 8, 2015, which claims the benefit of priority from German Patent Application Serial No. DE 10 2014 105 085.1 filed Apr. 9, 2014, the entire contents of which are herein incorporated by reference.

### DESCRIPTION

The present invention relates to a polymeric multilayer film that is at least in part translucent to electromagnetic radiation of a wavelength range of 150 to 600 nm and impermeable to organic volatile substances having a molecular mass of 20 to 300 gmol⁻¹ and includes at least one polyamide (PA) layer as well as at least one further layer of a different polymer material, characterized in that the multilayer film has a tension modulus of elasticity of 1 to 250 MPa or 1 to 500 MPa or 1 to 1000 MPa, measured in accordance with DIN EN ISO 527-1-3 with a test speed of 300 mm/min in machine direction (MD) and transverse direction (TD) after conditioning for 24 hours at 23° C. and a relative humidity of 50%, the use of a polymeric multilayer film as a tubular inner film for pipe liners in trenchless sewer rehabilitation or as sliding film, preliner, reinforcing or calibration hose of pipe liners in trenchless sewer rehabilitation, a pipe lining construction for trenchless sewer rehabilitation including a multilayer film as inner hose and a one layer or multilayer tubular film absorbing UV radiation and/or visible light and located on the sewer wall side as outer hose, wherein a carrier material impregnated with a reactive synthetic resin is provided between the inner hose and the outer hose, and a rehabilitated sewer section wherein the multilayer film is removable from the sewer section.

The scope of use of plastic films with multilayer structure is very extensive. The fields of use include, in addition to the packaging of foodstuff, as membrane films, as cable sheath or in the textile and clothing sector also the so-called pipe lining method for trenchless sewer rehabilitation. In trenchless sewer rehabilitation digging of sewer sections to be rehabilitated is omitted: through already existing manhole openings a flexible hose construction is introduced into the sewer section to be rehabilitated, which includes curable molding compounds of which a new pipe is manufactured on-site in the sewer section to be rehabilitated.

For instance, a hose construction (or pipe lining construction) including a curable resin is pulled in the sewer to be rehabilitated, is subsequently blown up using compressed air until the pipe lining construction fits positively on the sewer wall of the sewer to be rehabilitated, and subsequently is cured from inside of the blown up pipe lining construction, resulting in a “pipe in the pipe”. After curing of the resin the house connections are possibly milled using a sewer robot and joined to the rehabilitated sewer by way of so-called top-hat profiles.

To a skilled person, the structure and manufacture of such a pipe lining construction are known, for example, from WO 2007/054350 A1, DE 10 2007 038 869 B4, or EP 155 256 B1.

The pipe lining construction of the prior art essentially consists of two tubular films of different diameter between which a fabric layer impregnated with a curable resin is provided. Such a fabric layer may include a polyester needle felt or fleece of synthetic fibers, in particular polyamide fibers or glass fiber fabrics so as to form e.g. glass fiber reinforced plastic.

The one, inner tubular film (tubular inner film) is for lumen-side limiting of the pipe lining construction, the second, outer tubular film has a larger diameter than the inner tubular film and limits the pipe lining construction on the side of the sewer wall. The properties of the inner and outer tubular films are adapted to the respective requirements of the technology used for trenchless sewer rehabilitation: if the resin of the pipe lining construction is curable e.g. by UV light, the outer tubular film preferably is opaque for UV light in order to prevent early curing of the resin e.g. through sun light outside of the sewer to be rehabilitated, whereas the tubular inner film preferably is transparent for UV light, so that the resin of the pipe lining construction may be cured efficiently from the interior of the sewer after having been introduced into the sewer to be rehabilitated in that UV light sources are incorporated into the lumen of the blown up sewer.

Outer tubular films that absorb UV light and visible light, are known to a skilled person e.g. from WP 2010/075946 A1.

Tubular inner films that are transparent to UV light, are known to a person skilled in the art, for example, from DE 20 2010 016 048 U1, EP 0167 742 A2, DE 10 2010 023 764 A1 and EP 0 342 897 A2.

The length and diameter of a pipe lining construction correspond to the old pipe or to the type of sewer to be rehabilitated, and the wall thickness conforms to static provisions and is calculated therefrom. The felt or GRP fabric layer of the pipe lining construction is impregnated with resin in the production plant or in an on-site mobile impregnation system. A suitable resin mainly is an unsaturated polyester resin (ISO-NPG) or an epoxy resin or a vinyl ester resin. In particular cases (temperature, pH value), other types of resin may be used. The mechanical and physical-chemical properties of the pipe lining construction may be influenced by adding specific additives to the polymer base materials and/or to the resin.

The impregnated pipe lining construction is pulled in situ via existing manhole openings into the sewer to be rehabilitated (inversed or eversed). In inversion, after impregnation, the initial opening of the pipe lining construction is stretched over a frame on a 2-3 m high scaffold over the manhole at which rehabilitation is started. The pipe lining construction is “turned inside out” and filled e.g. with water, resulting in the fact that the pipe lining construction pulls (cards) itself into the sewer. The advantage of this is that the friction vis-à-vis the old pipe may be ignored, the sliding pipe lining construction glides through the water and fits positively on the old pipe. The resin reacts (cures) through the supply of power (hot water) in an exothermal reaction, resulting in a pipe in the pipe.

During eversion, the pipe lining construction is pulled in situ into the sewer to be rehabilitated e.g. by way of a winch, and is then blown up using compressed air. The reaction of the resin may be incited and supported by vapor or UV light. The advantages of those methods are a short curing time and less demand for energy, as heating of the entire volume of water in the pipe lining construction is omitted. Moreover, the water contaminated by resin components does not need to be disposed of specifically. Of disadvantage is the lower range of applications, rehabilitation of ducts in ground water or culverts often is not possible. In addition, the feasible limit for such pull-in methods at present is above DN 900 or above a wall thickness of approximately 14 mm. Larger diameters may be produced, however, the process technology and the narrowness predominating in a standard manhole will pose higher technical and physical challenges to sewer workers.

The pipe lining construction has to cure for some time (between 2 hours and several days, depending on the diameter and length) before the sewer may come on stream again. It then has a wall thickness depending on statics of at least 3 mm to 12 mm (or more, depending on the nominal width). Subsequently, possibly existing house connections can be milled using a sewer robot and then joined to the rehabilitated sewer by way of so-called top-hat profiles.

A pipe lining construction may be used as statically supporting pipe in the pipe. For this, the pipe lining construction has to fulfil the requirements of ATV data sheet 127-2 and is to be measured statically. According to the Deutsches Institut fir Bautechnik (DIBt) (German Institute for Structural Engineering) the material in this case is to have a ring stiffness of at least 5.000 N/m².

In the prior art, the process technology for curing a pipe lining construction can be divided into four main groups:
1. Inversion or eversion of the pipe lining construction through water pressure and curing by way of hot water.
2. Inversion or eversion of the pipe lining construction through air pressure and curing by way of vapor.
3. Pulling in of the pipe lining construction with the aid of a winch, positioning and compressing by way of air pressure and curing by way of UV sensitive photo initiators.
4. Combination of the pulling in and inversion method and curing by way of hot water.

In inversion, the pipe lining construction is brought into a rehabilitation position through turning inside out from the inner side to the outer side with the aid of water or air pressure, quite like pulling socks from the left side over to the right side. For this, depending on the depth of the position, a tower is to be built above the starting shaft so as to match the water pressure with the local conditions and the system conditions. In the inversion with the aid of compressed air, the pipe lining construction is brought into position via a drum. To this end, the pipe lining construction is fully coiled in a pressure-tight drum and subsequently is inversed with the aid of compressed air.

Basically, most of the pipe lining constructions used can be cured at an ambient temperature. However, higher reaction yields in forming the resin matrix are obtained if a reaction of the resins is initiated or supported by temperature.

Moreover, systems based on UV-VIS sensitive photo initiators become more and more popular. In this connection, according to a definition of the Deutsches Bundesamt fir Strahlenschutz (German Federal Agency for Radiation Protection), a skilled person comprehends by the term of ultraviolet (UV) radiation that includes a wavelength range of 100 nm to 400 nm. Light visible to humans is referred to as “VIS” and includes, for the purposes of the present invention, a wavelength range of 380 nm to 780 nm.

In the course of radiation, those systems initiate a reaction through the formation of chemical radicals. In so doing, radicals are formed through initiation due to radiation with UV light (by decay of the photo initiator) and a reaction is made possible. For initiating curing, a UV lamp train is moved through the pipe lining construction in the sewer to be rehabilitated by way of a sewer robot, UV radiation reaching the resin to be cured of the pipe lining construction through the tubular inner film and inciting curing thereof. At this, the UV radiation is to be matched exactly with the resin system.

In a UV-initiated reaction, the curing process is controlled via temperature sensors on the UV lamp train. The temperatures are transmitted to an operator controlling the UV lamp train that may then correct the moving speed of the UV lamp train.

Finally, in conventional trenchless sewer rehabilitation, the tubular inner film of the pipe lining construction is to be pulled off and removed, since the tubular inner film, being the inner layer, is exposed to substances to be passed through the pipe and conventional tubular inner films frequently cannot withstand such mechanical stress. The lack of mechanical robustness and in particular the lack of abrasion resistance of conventional tubular inner films leads to the fact that portions of the tubular inner film may become detached unintentionally, which portions then block pumps, sieves and pipes or generally increase environmental pollution.

By contrast, the tubular inner film of a pipe lining construction is to be well translucent to UV radiation and radiation of visible short-wavelength light. Thus, a curing process is made possible, which, in the pipe lining construction blown up in the pipe, is performed by a UV light source passing through the inner side of the pipe lining construction, i.e. within the tubular inner film.

To a skilled person, a multilayer film to be used as tubular inner film in trenchless sewer rehabilitation is known, for example, from EP 0 342 897 A2. EP 0 342 897 A2 discloses a multilayer film including a polyamide layer as first layer and an ionomer sealing layer as a second surface layer. If the multilayer film is used for pipe rehabilitation, the polyamide layer is bonded to a fibrous fleece by heating which then is impregnated with a curable resin. After conditioning of the film, i.e. swelling of the film in water up to weight constancy, the film, on its surface impregnated with resin, is then introduced into the area of the pipe inner wall to be rehabilitated, covering the total volume of the pipe in that area. After curing by way of UV radiation a stable pipe on the pipe inner wall to be rehabilitated is obtained in the area.

High mechanical demands are made to the tubular inner films of a pipe lining construction and/or to a multilayer film used for pipe rehabilitation, such as, for example, a multilayer film disclosed by EP 0 342 897 A2, so that the films withstand stresses occurring during use, e.g. during the introduction into the pipe to be rehabilitated, during blowing up of the respective film in the pipe, or, after successful rehabilitation, during removal from the pipe.

The disadvantage of a multilayer film as disclosed by EP 0342 897 A2 is that the film has a weak point at least in the area of the sealed seam, or, in conventional tubular films that are used in pipe rehabilitation as inner tubes of a pipe lining construction, that they do not have the required mechanical properties in order to withstand the above-described stresses. In addition, the requirement of a conditioning step prior to use of the multilayer film unnecessarily renders the process technology of sewer rehabilitation more complicate.

A disadvantage also is insufficient abrasion resistance of conventional tubular inner films with the consequence that those tubular inner films cannot remain in the rehabilitated sewer section, but have to be removed, thereby causing extra effort, time and costs.

A further disadvantage in conventional multilayer films used as tubular inner films inter alia is their low mechanical elasticity, particularly at temperatures below 0° C. In the worst case insufficient mechanical elasticity of the tubular inner film leads to bursting of the film when the pipe lining construction is blown up.

DE 10 2010 023 764 A1, for example, discloses a tubular inner film that, although having acceptable elasticity of an average of 40% at higher temperatures, is not suited for temperatures below 0° C. This restricts an efficient use of the multilayer film for trenchless sewer rehabilitation disclosed by DE 10 2010 023 764 A1 to warmer times of the year or warmer countries. The multilayer film disclosed in DE 10 2010 023 764 A1 has a layer sequence of a layer (a) based on at least one thermoplastic olefin, homo- or copolymer as one of the external layers, an adhesive-promoter layer (b), an internal layer (c) based on at least one homo- or copolyamide, an adhesive-promoter layer (d) and a layer (e) based on at least one homo- and/or copolyamide as one of the external layers. Thus, the multilayer film disclosed in DE 10 2010 023 764 A1 imperatively requires at least five layers, including at least two polyamide layers (c, e) and manufacture thereof therefore is comparatively expensive and complex.

The tubular inner films therefore have to meet highest demands with regard to their mechanical properties such as tensile strength, tear resistance, stretch, elasticity, tendency to splicing, impact strength, puncture resistance and abrasion resistance.

In conventional films that have at least one layer based on a polyamide, the mechanical properties may possibly be improved through conditioning. Conditioning in this case refers to a reversible absorption of liquid, preferably water, by one layer of the multilayer film or by the multilayer film up to weight constancy.

Multilayer films made of thermoplastic polyurethanes (TPU) are particularly elastic and flexible films of the prior art.

However, those TPU films do not have a barrier against organic monomers such as e.g. styrene and/or organic solvents that may leak from the resin layer of a pipe lining construction into the lumen of the pipe lining construction. Such leakage of organic monomers or solvents may constitute a danger of explosion in subsequent curing of the resin by UV light, since explosive air-monomer and/or air-solvents mixtures may be formed during curing. Those mixtures then may ignite e.g. on account of the high temperatures of the UV lamps used or on account of static charges.

Based on the prior art as disclosed in DE 10 2010 023 764 A1, it is therefore an object of the present invention to provide a multilayer film for trenchless sewer rehabilitation that meets the high demands with regard to elasticity and flexibility of a tubular inner film even at temperatures below 0° C., but nevertheless offers a reliable barrier against organic monomers and solvents, the multilayer film possibly remaining in the rehabilitated sewer.

The object is solved by a multilayer film that is at least in part translucent to electromagnetic radiation of a wavelength range of 150 to 600 nm and impermeable to organic volatile substances having a molecular mass of 20 to 300 gmol⁻¹ and includes at least one polyamide (PA) layer as well as at least one further layer of a different polymer material, characterized in that the multilayer film has a tension modulus of elasticity of 1 to 250 MPa or 1 to 500 MPa or 1 to 1000 MPa, measured in accordance with DIN EN ISO 527-1-3 with a test speed of 300 mm/min in machine direction (MD) and transverse direction (TD) after conditioning for 24 hours at 23° C. and a relative humidity of 50%, the use of a polymeric multilayer film as a tubular inner film for pipe liners in trenchless sewer rehabilitation or as sliding film, preliner, reinforcing or calibration hose of pipe liners in trenchless sewer rehabilitation, a pipe lining construction for trenchless sewer rehabilitation including a multilayer film as inner hose and a one layer or multilayer tubular film absorbing UV radiation and/or visible light and located on the sewer wall side as outer hose, wherein a carrier material impregnated with a reactive synthetic resin is provided between the inner hose and the outer hose, and a rehabilitated sewer section wherein the multilayer film is removable from the sewer section.

The present invention in particular relates to a multilayer film comprising at least one polyamide (PA) layer and at least one further layer of a different polymer material, is at least in part translucent to electromagnetic radiation of a wavelength range of 150 to 600 nm and impermeable to organic volatile substances having a molecular mass of 20 to 300 gmol⁻¹, such as, for example, organic monomers (e.g. styrene, divinylbenzene, ethene, ethyne, propylene) and solvents, such as e.g. toluene, ethanol and acetone, and has a tension modulus of elasticity (Young's modulus) of 1 to 250 MPa or 1 to 500 MPa or 1 to 1000 MPa, measured in accordance with DIN EN ISO 527-1-3 with a test speed of 300 mm/min in machine direction (MD) and transverse direction (TD) after conditioning for 24 hours at 23° C. and a relative humidity of 50%.

Although a similar multilayer film is known from the prior art of DE 10 2010 023 764 A1, it is the merit of the inventors of the present application to have recognized that a modulus of elasticity within a region of 1-1000 MPa, in particular 1 to 500 MPa, preferably 1-250 MPA is decisive for the application and use of the present invention in trenchless sewer rehabilitation. Only multilayer films that are within the above-indicated modulus of elasticity range exhibit the mechanical properties such as elasticity, tensile strength and abrasion resistance required for sewer rehabilitation, particularly at temperatures below 0° C.

As opposed to the multilayer film known from DE 10 2010 023 764 A1 the multilayer film in accordance with the invention does not imperatively require two polyamide layers and moreover may have less than five layers while nevertheless offering advantageous mechanical properties such as a low modulus of elasticity and high elasticity even at temperatures below 0° C., as well as reliable protection against leaking organic monomers and solvents.

Therefore, as opposed to the prior art known from DE 10 2010 023 764 A1 the multilayer film in accordance with the invention not only makes manufacture of the multilayer film possible that is accelerated and less costly, but also enables applicability of the multilayer film e.g. as tubular inner film in trenchless sewer rehabilitation that is not restricted by weather conditions or temperature ranges.

Due to the high translucency of the multilayer film to UV radiation (preferably 80%, of particular preference 90%) effective curing of the resin is made possible in case the multilayer film is used within the scope of a pipe lining construction that is set up and compressed by way of air pressure and then is cured by way of UV sensitive photo initiators.

The barrier function of the multilayer film in accordance with the invention vis-à-vis organic monomers and solvents is extremely important since organic monomers and/or solvents leaking from the resin layer into the lumen of the pipe lining construction may form an easily ignitable mixture with the air, which may lead to danger of explosion on account of the high temperatures occurring during curing with the aid of UV light. In contrast to conventional multilayer films on a TPU basis that exhibit similar elasticity and tensile properties, the multilayer film in accordance with the invention offers reliable protection against leaking volatile substances such as organic solvents and monomers at constant advantageous, if not better, elasticity and tensile properties.

Those advantageous elasticity and tensile properties are reflected in a low modulus of elasticity of the film in accordance with the invention. A low tension modulus of elasticity (Young's modulus) of 1 to 1000 MPa, in particular 1 to 500 MPa, preferably 1 to 250 MPA, is a characteristic feature of a soft, elastic film.

High elasticity and thus flexibility of the multilayer film in accordance with the invention reduces the danger of bursting or splicing (tearing of an inner film layer) when the film is stretched e.g. during blowing up or already during pulling in into a sewer to be rehabilitated. The multilayer film in accordance with the invention has such advantageous mechanical properties also at temperatures below 0° C., which enables the use of the multilayer film in accordance with the invention as tubular inner film of a pipe lining construction for trenchless sewer rehabilitation also in central European winter. Moreover, the multilayer film in accordance with the present invention is particularly resistant to abrasion.

Although also the multilayer film disclosed in DE 10 2010 023 764 A1, as most conventional films, at 20° C. has an elasticity of 40% up to breakage, the inventors of the known multilayer film, as explained above, have not recognized the importance of the modulus of elasticity for applicability of the multilayer film in trenchless sewer rehabilitation at lower temperatures, particularly below 0° C.

In setting the modulus of elasticity of the multilayer film in accordance with claim 1 to a range of between 1 and 1000 mPa, 1 to 500 and in particular 1 to 250 MPa, it is safeguarded that the multilayer film in accordance with the invention, in a blow-up test up to bursting, has an elasticity of between 80 and 1000%, in particular 80 to 400%, and preferably 80 to 200%, even at temperatures below 0° C., particularly in a temperature range of between −80° C. to 0° C., preferably between −40° C. to 0° C., and especially preferred between −20° C. and 0° C., the maximum elasticity in % being calculated from [(hose diameter after blow-up/initial hose diameter prior to blow-up)−1]×100. Such a connection between the modulus of elasticity of a multilayer film and elasticity thereof at temperatures below 0° C. was not recognized by the inventors of the multilayer film in accordance with DE 10 2010 023 764 A1. Measurements of mechanical properties such as the modulus or elasticity or the flexibility up to bursting at temperatures below 0° C. were not carried out and are neither disclosed in DE 10 2010 023 764 A1, nor are they included therein implicitly.

It is preferred that the multilayer film of the present invention includes at least one polyamide of the at least one polyamide layer having a tension modulus of elasticity of 1 to 500 MPa, measured in accordance with DIN EN ISO 527-1-3 with a test speed of 300 mm/min in machine direction (MD) and transverse direction (TD) after conditioning for 24 hours at 23° C. and a relative humidity of 50%.

Surprisingly, this is sufficient in order to impart the desired softness, elasticity and abrasion resistance to the entire multilayer film.

On account of the low modulus of elasticity of the multilayer film in accordance with the invention, abrasion resistance thereof also is enhanced surprisingly, as the multilayer film elastically yields e.g. when quartz gravel granules hit the surface of the multilayer film, thus reducing the surface forces eroding the multilayer film. On account of the high abrasion resistance of the multilayer film in accordance with the invention the multilayer film, if used as tubular inner film of a pipe lining construction, in contrast to the tubular inner films of the prior art, may remain in the rehabilitated sewer section after trenchless sewer rehabilitation, which renders process engineering of trenchless sewer rehabilitation easier, quicker, and reduces the costs thereof.

Although also the inventors of DE 10 2010 023 764 A1 claim that the multilayer film disclosed therein may remain in the rehabilitated sewer, no measuring data for abrasion resistance of the multilayer film are disclosed in DE 10 2010 023 764 A1, as the inventors also have not recognized the connection between the modulus of elasticity and abrasion resistance. Thus, it is questionable if the multilayer film disclosed in DE 10 2010 023 764 A1 as tubular inner film in the long term could withstand mechanical stress on the lumen-side wall of a rehabilitated sewer without at least portions of the film detaching from the lumen-side wall of a pipe lining construction introduced into a sewer.

What is decisive for the applicability of the multilayer film in accordance with the invention even at temperatures below 0° C. is to deliberately set the modulus of elasticity of the multilayer film to a range of 1 to 1000 MPa, or 1 to 500 MPa, in particular 1 to 250 MPa. By setting and varying the tension modulus of elasticity within the range of 1 to 250 MPa the mechanical properties of the multilayer film may be tailored to specific requirements. Based on the specific requirements of the respective application, preferred embodiments multilayer film in accordance with the invention each have a tension modulus of elasticity in a range of 10 to 200 MPa, preferably 20 to 180 MPa, preferably 30 to 180 MPa, and a particularly preferred range of 50 to 150 MPa.

Moreover, the composition of the further polymer layer(s) may be varied and adapted respectively to specific requirements and applications. In a further preferred embodiment of the invention the further polymer layer from a different polymer material may include a starting substance from a different polymer material that is selected from the group consisting of: ethylene (meth) acrylate copolymer, thermoplastic olefin-homo- or copolymer, ethylene homopolymer (polyethylene, PE), polyethylene of low density (LDPE), LLDPE (linear low density polyethylene), polyethylene of high density (HDPE), PE (mPE) polymerized on the basis of metallocene catalysts, polypropylene homopolymers (polypropylene, PP), polypropylene random copolymers (polypropylene, random PP), butylene homopolymers (polybutylene, PB), isobutylene homopolymers (polyisobutylene, PI), ethylene vinyl alcohol copolymer (EVOH), polyvinyl alcohol (PVOH), cyclic olefin copolymer (COC), thermoplastic elastomers (TPE), particularly on the basis of PA elastomers, preferably PA 12 elastomers, block copolymers of PA12 segments and polyether segments or on a urethane basis (TPU) and a combination of two or more of the above-indicated starting substances.

If required, also adhesive-promoter layers may be provided between individual polymer layers of the multilayer film. Moreover, the multilayer film also may be powdered in order to improve its sliding capacity.

Furthermore, the properties of the multilayer film may be varied by adding different additives to the starting substances of one or more layers. Thus, e.g. in a further embodiment of the present invention, at least one of the layers of the multilayer film includes at least one additive that is selected from the group consisting of: antistatic agents, antioxidants, oxygen scavengers, antiblocking agents, anti-fog agents, antimicrobial agents, dyes, color pigments, stabilizers, preferably heat stabilizers, process stabilizers, process aids, flame retardants, nucleating agents, crystallizing agents, preferably crystal nucleating agents, lubricants, optical brighteners, flexibilization agents, sealing agents, softeners, silanes, spacers, fillers, peel-additives, waxes, wetting agents, surface active compounds, preferably tensides, UV stabilizers and disperging agents.

Preferably, the multilayer film in accordance with the invention is formed as a hose, in particular a tubular inner film of a pipe lining construction for trenchless sewer rehabilitation.

Preferably, the hose is manufactured through (co) extrusion, particularly preferred through blow film (co)extrusion and preferably without sealed seam.

Tubular films without sealed seam are particularly robust and have less weak spots than tubular films formed by sealing a flat film. Alternatively, the multilayer film in accordance with the invention in the shape of a tubular film may be obtained as a cast film through cast (co)extrusion or as other flat film. Such films may then be sealed to form a hose. Stamping, stretching and/or printing of the multilayer film in accordance with the invention may be of advantage.

The elasticity of the multilayer film is measured on a hose formed of the multilayer film. In accordance with the invention the multilayer film has a maximum elasticity of 10% at −1° C. in a radial direction, a preferred elasticity of approximately 15%, and preferably an elasticity of approximately 20% until splicing, i.e. until tear of an inner film layer for the first time. In accordance with the invention the multilayer film has a maximum elasticity of at least 20% at 20° C. in a radial direction, a preferred elasticity of approximately 25%, and preferably an elasticity of approximately 30% until splicing, i.e. until an inner film layer tears for the first time. The elasticity up to bursting, both at low temperatures (below 0° C.) and at higher temperatures (for example, 20° C.), preferably amounts to at least 80%, preferred at least 100%, particularly preferred at least 110% and most preferred at least 120% and even at least 130%.

In a further preferred embodiment, the multilayer film in accordance with the invention has an abrasion depth preferably in a range of between 0.001 and 0.03 mm, particularly preferred between 0.003 and 0.02 mm in accordance with DIN EN 295-3 (Darmstadt tipping trough, minimum numbers of alternations of load 100,000).

Due to a high abrasion resistance of the multilayer film in accordance with the invention the multilayer film, if used as a tubular inner film of a pipe lining construction, after trenchless sewer rehabilitation may remain in the rehabilitated sewer section, which simplifies the process engineering of trenchless sewer rehabilitation.

In a preferred embodiment of the present invention the polyamide layer of the multilayer film includes a homo or copolyamide that is selected from the group consisting of: thermoplastic, aliphatic, partially aromatic or aromatic homo or copolyamides, in particular PA6, PA12, PA66, PA10, PA 11, PA 666, PA6I, PA 6,12, PA6T, PA elastomers, terpolyamides, quaterpolyamides, block copolymers of PA12 segments and polyether segments or a mixture of at least two of the above-indicated polyamides.

The polyamide layer serves as barrier against organic solvents and/or monomers that may leak from the resin into the lumen of the pipe lining construction and thus lead to danger of explosion.

For manufacturing the barrier layer, also at least ethylene vinyl alcohol copolymer (EVOH), polyvinyl alcohol (PVOH), cyclic olefin copolymer (COC) polyvinylidene chloride (PVdC) or a mixture of at least two of the above-indicated polymers or a mixture of a homo or copolyamide with one of the above-indicated polymers can be used alternatively. Preferably, in manufacturing the multilayer film in accordance with the invention, particularly soft polyamides with a low tension modulus of elasticity are used. This entails the advantage e.g. vis-à-vis conventional elastic and tensile tubular inner films on TPU basis that a film is provided that has better mechanical properties such as elasticity and flexibility as well as a barrier function against organic monomers and/or solvents.

For adapting the mechanical properties of the multilayer film to the respective requirements the polyamide layer may be softened additionally e.g. by way of (preferably food compatible) softeners, so that also pipes conducting drinking water can be rehabilitated.

In a further preferred embodiment the total thickness of the multilayer film varies in a range of 10 to 4000 μm, preferably 40 to 2000 μm, particularly preferred from 60 to 1000 μm, in particular 80 to 400 μm. This allows for adapting the multilayer film to the size or sewer type of the sewer to be rehabilitated and possibly allows for a reduction of the manufacturing costs by using each of the thinnest possible multilayer film for one respective application.

In different embodiments the layer thickness of the polyamide layer varies between 1 μm to 200 μm, preferably between 5 and 100 μm, particularly preferred between 20 μm and 80 μm. In varying the layer thickness and composition of the polyamide layer the modulus of elasticity of the entire multilayer film may be regulated. Moreover, by the use of thinner polyamide layers the manufacturing costs of the multilayer film may be reduced.

The use of the multilayer film in accordance with the invention as tubular inner film in trenchless sewer rehabilitation is of particular advantage as due to the high elasticity and softness (low tension modulus of elasticity) and high flexibility of the multilayer film of the invention splicing or even bursting of the multilayer film during its blowing up in the sewer to be rehabilitated is prevented. In contrast to conventional tubular inner films the advantageous high flexibility of the multilayer film in accordance with the invention also is safeguarded at temperatures below 0° C., which substantially simplifies rehabilitation works in central European winter. Tests have revealed that the hose formed of the multilayer film in radial direction in a blow-up test up to bursting, has an elasticity of between 80 and 1000%, in particular 80 to 400%, and preferably 80 to 200%, even at temperatures of −80° C. to 0° C., particularly between −40° C. to 0° C., and preferred between −20° C. and 0° C., the maximum elasticity in % being calculated from [(hose diameter after blowing up/initial hose diameter prior to blowing up)−1]×100. In combination with the advantageous high elasticity and flexibility the multilayer film in accordance with the invention further includes a barrier against organic monomers and solvents that may leak, for example, from the resin into the lumen of the sewer to be rehabilitated. This is a clear improvement vis-à-vis the TPU films known from the prior art that, although having similar elasticities and flexibilities, do not offer protection against leaking organic monomers and solvents. Furthermore, the multilayer film in accordance with the invention has particularly good abrasion resistance.

In addition to the use of the multilayer film as tubular inner film the multilayer film also may be used as sliding film, preliner, or reinforcing or calibration hose of a pipe lining construction in trenchless sewer rehabilitation. The multilayer film in accordance with the invention cannot only be used for sewer rehabilitation by way of UV curing or curing with short-wave visible light as described above, but also in pipe rehabilitation systems in which the pipe lining construction (including the multilayer film in accordance with the invention) is cured thermally, or in which the inversion method is applied. The multilayer film in accordance with the invention also may be used in form of a preliner or a reinforcing and/or calibration film.

Within the meaning of the present invention the preliner is to be comprehended as a film, preferably in form of a film hose or a flat film sealed to form a hose that is introduced between the sewer wall of the sewer to be rehabilitated and the pipe lining construction. At this, the film as a preliner fulfills a number of duties, such as, for example, preventing that the resin adheres to the sewer wall and e.g. avoiding contact of dirt and water with the not yet cured resin. Furthermore, the preliner also prevents leakage of resin from the sewer rehabilitation system as well as a contamination of ground and groundwater. Moreover, the feed lines are protected against penetrating excess resin, so that no resin clots and blockages may be formed.

The use of the multilayer film in accordance with the invention as preliner also is similar to the function as sliding film for the pipe lining construction to be pulled in. The use of the described multilayer film in accordance with the invention therefore also relates to a use as tubular sliding film in the pipe lining method in the course of trenchless sewer rehabilitation. In this case it is the low friction coefficients between the sliding film and the outer film of the pipe lining construction that matter.

The function of a calibration hose essentially corresponds to the tubular inner film in the system of a UV light curing glass fiber pipe lining construction and is arranged in the pipe lining construction as the tubular inner film. Often, a calibration hose on its outer side (i.e. when in use, towards the sewer wall) is bonded to a fleece or felt. If a calibration hose is used, a tubular inner film may be dispensed with. When using the film in accordance with the invention as calibration hose resin may be applied also on both sides. Preferably the resin is brought into contact with the film by a carrier impregnated with resin, e.g. glass fibers or synthetic fiber felts. The layer(s) of the film in accordance with the invention to be activated then bond with the resin or with a resin impregnated carrier material (such as fleece, felt, textile fabric, etc.). Thus, a pipe within the pipe is obtained.

Preferably, a multilayer film is used as tubular inner film, sliding film, preliner, reinforcing or calibration hose, that in a radial direction has an elasticity up to bursting of at least approximately 20%, preferably higher than approximately 80% at −1° C.

Preferably, a multilayer film is used as tubular inner film, sliding film, preliner, reinforcing or calibration hose, the abrasion depth of which in accordance with DIN EN 295-3 is lower than 0.03 mm, preferably lower than 0.02 mm, preferably lower than 0.01 mm, and particularly preferred in a range of between 0.001 and 0.03 mm, preferably between 0.003 and 0.02 mm.

Preferably, the multilayer film used as tubular inner film, sliding film, preliner, reinforcing or calibration hose has a polyamide layer including a homo or copolyamide that is selected from the group consisting of: thermoplastic, aliphatic, partially aromatic or aromatic homo or copolyamides, in particular PA6, PA12, PA66, PA10, PA 11, PA 666, PA6I, PA 6,12, PA6T, polyamide elastomers, terpolyamides, quaterpolyamides, block copolymers of PA12 segments and polyether segments or a mixture of at least two of the above-indicated polyamides.

In one use of the multilayer film in accordance with the invention it may be used in a conditioned or non-conditioned state. By conditioning, a reversible absorption of humidity, preferably water, by a thermoplastic synthetic material such as homo or copolyamide or by the entire multilayer film is to be comprehended. Conditioning has an influence on the mechanical properties of the multilayer film.

A further aspect of the present invention relates to a pipe lining construction for trenchless sewer rehabilitation. Such a pipe lining construction includes a multilayer film in accordance with the invention as tubular inner film and a one or multilayer tubular film absorbing or reflecting UV radiation and/or visible light and located on the sewer wall side as outer hose, a carrier material impregnated with a reactive synthetic resin being provided between the tubular inner film and the outer hose. Such a pipe lining construction in accordance with the invention is particularly safe since, on account of high elasticity and flexibility of the tubular inner film, bursting or splicing of the tubular inner film e.g. in blowing up the pipe lining construction in a sewer to be rehabilitated and hence leakage of uncured resin through cracks in the tubular inner film is almost excluded. On account of the barrier function of the polyamide layer of the tubular inner film organic monomers and solvents cannot leak into the lumen of the pipe lining construction and mix therein with air to form an inflammable mixture. As the multilayer film in accordance with the invention also has very advantageous mechanical properties (elasticity, flexibility) also at temperatures below 0° C., particularly in a temperature range of −80° C. to 0° C., in particular −40° C. to 0° C., preferably −20° C. to 0° C., the pipe lining construction in accordance with the invention also functions without problems in central European winter. On account of the high abrasion resistance of the multilayer film in accordance with the invention the film, after curing of the resin, may remain in the sewer section rehabilitated and does not have to be removed. This renders the pipe lining construction in accordance with the invention particularly user-friendly.

A different aspect of the present invention relates to a rehabilitated sewer section of a sewer for the transport of liquids, gases or solids and a pipe lining construction in accordance with the invention that is arranged so as to fit closely to the sewer wall in the direction of the liquids, gas or solids to be transported and in which a carrier material is located between an inner hose and a hose lying on the side of the sewer wall and including a cured synthetic resin.

In an embodiment the multilayer film provided as tubular inner film remains in the rehabilitated sewer section.

Alternatively, the multilayer film provided as tubular inner film is removed, as in conventional methods for trenchless sewer rehabilitation, from the rehabilitated sewer section after the resin is cured.

Per definition, the multilayer film in accordance with the invention has two or more layers.

Further advantages and features are to be seen from the description of embodiments.

### EXAMPLES

Six different multilayer films in accordance with the invention (Examples 1 to 8, B1 to B8) are compared with two established tubular inner films already known from the prior art (comparative examples 1 and 2, V1 and V2) with regard to their layer structure, flexibility, mechanical properties and abrasion resistance.

The multilayer films of the comparative examples each consist of five layers. The multilayer films in accordance with the invention each consist of five (B1 to B4) or three (B5 and B6) layers. The individual layers of the multilayer films each directly adjoin each other in the order in which they are listed subsequently. Both the multilayer films of comparative examples V1 and V2 and those of examples B1 to B8 were manufactured through blow film co-extrusion.

### Comparative Example 1

### Prior Art

| Layer | | Proportion | Thickness in |
|---|---|---|---|
| number | Composition | in layer in % | μm |
| (1) | Copolyamide of | 88 | 40 |
| | average viscosity, Young's | | |
| | modulus of 1200 MPa | | |
| | Homopolyamide of high | 12 | |
| | viscosity, Young's modulus | | |
| | of 2800 Mpa | | |
| (2) | Adhesive-promoter | 100 | 10 |
| (3) | Polyethylene of low | 70 | 65 |
| | density (LDPE), Young's | | |
| | modulus of 260 MPa | | |
| | Ethylene copolymer | 30 | |
| | produced through | | |
| | metallocene catalysis, | | |
| | modulus of elasticity <330 MPa | | |
| (4) | Adhesive-promoter | 100 | 10 |
| (5) | Polyethylene of low | 70 | 75 |
| | density (LDPE), Young's | | |
| | modulus of 260 MPa | | |
| | Ethylene copolymer | 30 | |
| | produced through | | |
| | metallocene catalysis, | | |
| | Young's modulus <330 MPa | | |
| Overall | Overall Young's modulus | | Overall |
| film | (MD/TD): | | thickness: |
| | 325/342 MPa | | 200 μm |

### Comparative Example 2

### Prior Art

| Layer | | Proportion | Thickness in |
|---|---|---|---|
| number | Composition | in layer in % | μm |
| (1) | Copolyamide of | 88 | 40 |
| | average viscosity, Young's | | |
| | modulus of 1200 MPa | | |
| | Homopolyamide of high | 12 | |
| | viscosity, Young's modulus | | |
| | of 2800 Mpa | | |
| (2) | Adhesive-promoter | 100 | 10 |
| (3) | Polyethylene of low | 70 | 25 |
| | density (LDPE), Young's | | |
| | modulus of 260 MPa | | |
| | Ethylene copolymer | 30 | |
| | produced through | | |
| | metallocene catalysis, | | |
| | Young's modulus <330 MPa | | |
| (4) | Adhesive-promoter | 100 | 10 |
| (5) | Polyethylene of low | 70 | 35 |
| | density (LDPE), Young's | | |
| | modulus of 260 MPa | | |
| | Ethylene copolymer | 30 | |
| | produced through | | |
| | metallocene catalysis, | | |
| | Young's modulus <330 MPa | | |
| Overall | Overall Young's modulus | | Overall |
| film | (MD/TD): | | thickness: |
| | 275/279 Mpa | | 120 μm |

### Example 1

### Multilayer Film in Accordance with the Invention

| Layer | | Proportion | Thickness in |
|---|---|---|---|
| number | Composition | in layer in % | μm |
| (1) | Polyamide with a | 100 | 40 |
| | Young's modulus <200 Mpa | | |
| (2) | Adhesive-promoter | 100 | 10 |
| (3) | Polyethylene of low | 70 | 65 |
| | density (LDPE), Young's | | |
| | modulus of 260 MPa | | |
| | Ethylene copolymer | 30 | |
| | produced through | | |
| | metallocene catalysis, | | |
| | Young's modulus <330 MPa | | |
| (4) | Adhesive-promoter | 100 | 10 |
| (5) | Polyethylene of low | 70 | 75 |
| | density (LDPE), Young's | | |
| | modulus of 260 MPa | | |
| | Ethylene copolymer | 30 | |
| | produced through | | |
| | metallocene catalysis, | | |
| | Young's modulus <330 MPa | | |
| Overall | Overall Young's modulus | | Overall |
| film | (MD/TD): | | thickness: |
| | 175/170 Mpa | | 200 μm |

### Example 2

### Multilayer Film in Accordance with the Invention

| Layer | | Proportion | Thickness in |
|---|---|---|---|
| number | Composition | in layer in % | μm |
| (1) | Polyamide with a | 100 | 40 |
| | Young's modulus <200 Mpa | | |
| (2) | Adhesive-promoter | 100 | 10 |
| (3) | Polyethylene of low | 70 | 25 |
| | density (LDPE), Young's | | |
| | modulus of 260 MPa | | |
| | Ethylene copolymer | 30 | |
| | produced through | | |
| | metallocene catalysis, | | |
| | Young's modulus <330 MPa | | |
| (4) | Adhesive-promoter | 100 | 10 |
| (5) | Polyethylene of low | 70 | 35 |
| | density (LDPE), Young's | | |
| | modulus of 260 MPa | | |
| | Ethylene copolymer | 30 | |
| | produced through | | |
| | metallocene catalysis, | | |
| | Young's modulus <330 MPa | | |
| Overall | Overall Young's modulus | | Overall |
| film | (MD/TD): | | thickness: |
| | 170/173 Mpa | | 120 μm |

### Example 3

### Multilayer Film in Accordance with the Invention

| Layer | | Proportion | Thickness in |
|---|---|---|---|
| number | Composition | in layer in % | μm |
| (1) | Polyamide with a | 100 | 40 |
| | Young's modulus of | | |
| | approx. 450 Mpa | | |
| (2) | Adhesive-promoter | 100 | 10 |
| (3) | Polyethylene of low | 70 | 65 |
| | density (LDPE), Young's | | |
| | modulus of 260 MPa | | |
| | Ethylene copolymer | 30 | |
| | produced through | | |
| | metallocene catalysis, | | |
| | Young's modulus <330 MPa | | |
| (4) | Adhesive-promoter | 100 | 10 |
| (5) | Polyethylene of low | 70 | 75 |
| | density (LDPE), Young's | | |
| | modulus of 260 MPa | | |
| | Ethylene copolymer | 30 | |
| | produced through | | |
| | metallocene catalysis, | | |
| | Young's modulus <330 MPa | | |
| Overall | Overall Young's modulus | | Overall |
| film | (MD/TD): | | thickness: |
| | 186/187 Mpa | | 200 μm |

### Example 4

### Multilayer Film in Accordance with the Invention

| Layer | | Proportion | Thickness in |
|---|---|---|---|
| number | Composition | in layer in % | μm |
| (1) | Polyamide with a | 100 | 40 |
| | Young's modulus of | | |
| | approx. 200 Mpa | | |
| (2) | Adhesive-promoter | 100 | 10 |
| (3) | Polyethylene of low | 70 | 65 |
| | density (LDPE), Young's | | |
| | modulus of 260 MPa | | |
| | Ethylene copolymer | 30 | |
| | produced through | | |
| | metallocene catalysis, | | |
| | Young's modulus <330 MPa | | |
| (4) | Adhesive-promoter | 100 | 10 |
| (5) | Polyethylene of low | 70 | 75 |
| | density (LDPE), Young's | | |
| | modulus of 260 MPa | | |
| | Ethylene copolymer | 30 | |
| | produced through | | |
| | metallocene catalysis, | | |
| | Young's modulus <330 MPa | | |
| Overall | Overall Young's modulus | | Overall |
| film | (MD/TD): | | thickness: |
| | 182/181 Mpa | | 200 μm |

### Example 5

### Multilayer Film in Accordance with the Invention

| Layer | | Proportion | Thickness in |
|---|---|---|---|
| number | Composition | in layer in % | μm |
| (1) | Polyamide with a | 100 | 40 |
| | Young's modulus <200 Mpa | | |
| (2) | Adhesive-promoter | 100 | 10 |
| (3) | Polyethylene of low | 40 | 150 |
| | density (LDPE), Young's | | |
| | modulus of 260 MPa | | |
| | Polar copolymer of | 60 | |
| | ethylene and butyl acrylate | | |
| | of low crystality, Young's | | |
| | modulus of 60 MPa | | |
| Overall | Overall Young's modulus | | Overall |
| film | (MD/TD): | | thickness: |
| | 140/141 Mpa | | 200 μm |

### Example 6

### Multilayer Film in Accordance with the Invention

| Layer | | Proportion | Thickness in |
|---|---|---|---|
| number | Composition | in layer in % | μm |
| (1) | Polyamide with a | 100 | 40 |
| | Young's modulus <200 Mpa | | |
| (2) | Adhesive-promoter | 100 | 10 |
| (3) | Ethylene-based octen | 90 | 70 |
| | plastomer produced | | |
| | through metallocene | | |
| | catalysis, Young's modulus | 10 | |
| | of 65 MPa | | |
| | Polyethylene of lower | | |
| | density (LDPE), Young's | | |
| | modulus of 260 MPa | | |
| Overall | Overall Young's modulus | | Overall |
| film | (MD/TD): | | thickness: |
| | 124/124 Mpa | | 120 μm |

### Example 7

### (Multilayer Film in Accordance with the Invention), Polyamide Mixture

| Layer | | Proportion | Thickness in |
|---|---|---|---|
| number | Composition | in layer in % | μm |
| (1) | Copolyamide of | 88 | 40 |
| | average viscosity, Young's | | |
| | modulus of approx. 1200 Mpa | | |
| | Polyamide with a | 12 | |
| | Young's modulus <200 MPa | | |
| (2) | Adhesive-promoter | 100 | 10 |
| (3) | Polyethylene of low | 70 | 65 |
| | density (LDPE), Young's | | |
| | modulus of 260 MPa | | |
| | Ethylene copolymer | 30 | |
| | produced through | | |
| | metallocene catalysis, | | |
| | Young's modulus <330 MPa | | |
| (4) | Adhesive-promoter | 100 | 10 |
| (5) | Polyethylene of low | 70 | 75 |
| | density (LDPE), Young's | | |
| | modulus of 260 MPa | | |
| | Ethylene copolymer | 30 | |
| | produced through | | |
| | metallocene catalysis, | | |
| | Young's modulus <330 MPa | | |
| Overall | Overall Young's modulus | | Overall |
| film | (MD/TD): | | thickness: |
| | 220/225 Mpa | | 200 μm |

### Example 8

### (Multilayer Film in Accordance with the Invention), Polyamide Mixture

| Layer | | Proportion | Thickness in |
|---|---|---|---|
| number | Composition | in layer in % | μm |
| (1) | Copolyamide of | 88 | 40 |
| | average viscosity, Young's | | |
| | modulus of approx. 1200 Mpa | | |
| | Polyamide with a | 12 | |
| | Young's modulus <200 MPa | | |
| (2) | Adhesive-promoter | 100 | 10 |
| (3) | Polyethylene of low | 70 | 25 |
| | density (LDPE), Young's | | |
| | modulus of 260 MPa | | |
| | Ethylene copolymer | 30 | |
| | produced through | | |
| | metallocene catalysis, | | |
| | Young's modulus <330 MPa | | |
| (4) | Adhesive-promoter | 100 | 10 |
| (5) | Polyethylene of low | 70 | 35 |
| | density (LDPE), Young's | | |
| | modulus of 260 MPa | | |
| | Ethylene copolymer | 30 | |
| | produced through | | |
| | metallocene catalysis, | | |
| | Young's modulus <330 MPa | | |
| Overall | Overall Young's modulus | | Overall |
| film | (MD/TD): | | thickness: |
| | 205/205 Mpa | | 120 μm |

Measurement of Elasticity (Blow-Up Test)

For measuring the elasticity a tubular film with a length of 5 m and produced through blow film co-extrusion, which has a circumference of the hose of 1175 mm to 1180 mm, is hermetically sealed on both ends by way of two packers (metal plates). Through a valve in one of the two packers compressed air (up to more than 1 bar) then is increasingly introduced into the tubular film until it bursts, a maximum extension being ascertained in that the outer circumference of the hose that is obtained until the hose bursts is measured at its largest position and is compared to the initial diameter of the hose, the formula for elasticity being as follows:

Maximum elasticity in %=[(hose diameter after blow-up/initial hose diameter prior to blow-up)−1]×100.

The same formula holds for “film splicing”, i.e. first noticeable tear-off of one layer of the tubular film (without the entire film being affected):

Splicing in %=[(hose diameter after blow-up and first noticeable tear-off of one film layer/initial hose diameter prior to blow-up)−1]×100.

Results from the Blow Up Tests at −1° C. and 20° C.

Table 1 shows the results of the blow-up tests for multilayer films V1 and V2, as well as for multilayer films B1 to B8 in accordance with the invention. For better comparability, the results of the elasticity measurement of the multilayer films disclosed in DE 10 2010 023 764 A1 are indicated in brackets (Examples (Ex. 1)-(Ex. 4)).

TABLE 1
Results from the blow-up tests

| | Thickness in | | Elasticity |
|---|---|---|---|
| Example/ | μm | | [%] up to |
| Comparative | (Number of | Splicing [%] | bursting |
| example | layers) | −1° C./20° C. | −1° C./20° C. |
| V1 | 200 | 5.1/15.9 | 15.8/80.5 |
| | (5) | | |
| V2 | 120 | 6.2/20.9 | 17.0/95.7 |
| | (5) | | |
| B1 | 200 | 17.3/40.2 | 135.9/175.2 |
| | (5) | | |
| B2 | 120 | 16.6/39.4 | 126.0/161.0 |
| | (5) | | |
| B3 | 200 | 11.4/28.3 | 101.7/135.2 |
| | (5) | | |
| B4 | 200 | 16.0/30.3 | 112.0/145.9 |
| | (5) | | |
| B5 | 200 | No Splicing | 145.2/164.3 |
| | (3) | | |
| B6 | 120 | No Splicing | 134.3/153.8 |
| | (3) | | |
| B7 | 200 | 10.2/26.7 | 100.2/127.9 |
| | (5) | | |
| B8 | 120 | 10.1/25.9 | 103.7/124.8 |
| | (5) | | |
| (Ex. 1) | 140 | Not indicated | Not indicated/ |
| DE 10 2010 023 764 A1 | (5) | | 80.2 |
| (Ex. 2) | 150 | Not indicated | Not indicated/ |
| DE 10 2010 023 764 A1 | (5) | | 34.1 |
| (Ex. 3) | 140 | Not indicated | Not indicated/ |
| DE 10 2010 023 764 A1 | (5) | | 39.4 |
| (Ex. 4) | 300 | Not indicated | Not indicated/ |
| DE 10 2010 023 764 A1 | (5) | | 16.9 |

The films of comparative examples 1 and 2 are used already as tubular inner films for pipe lining constructions within the scope of trenchless sewer rehabilitation. Although those films function perfectly at temperatures of approximately 15 to 30° C., there is the danger that the mechanical properties of those films are insufficient at lower temperatures, i.e. at about −1° C. This is also proved by the results of comparative examples 1 and 2. Thus, in comparative example V1, splicing, i.e. first noticeable tear-off of film layers, occurs at −1° C. already at an expansion of 5.1%, whereas at 20° C. the value of 15.9% is a good value. Exactly the same applies to the film of comparative example V2 (splicing at −1° C.=6.2%, at 20° C., splicing occurs only at 20.9%). The films of comparative examples V1 and V2 thus are of limited suitability as tubular inner films at low temperatures. A further evidence for this is an expansion up to bursting of the films of V1 and V2. The film of V1 bursts at −1° C. already at an expansion of 15.8%, the film of V2 at 17.0%. What is required is a minimum expansion up to bursting of 15%, which is just fulfilled by the films of V1 and V2, but which quite often is not fulfilled in practice. However, the problem does not occur at temperatures of 20° C. Here, in V1 and V2, expansions up to bursting or more than 80% are achieved. No measuring values of elasticity at −1° C. are provided for the films disclosed in DE 10 2010 023 764 A1 (Ex. 1)-(Ex. 4). However, since already at 20° C. elasticity of those films as opposed to that of the multilayer films of the present invention of examples B1-B8 is ten times lower (16.9% vs. 175.2%), it is very unlikely that the films disclosed in DE 10 2010 023 764 A1 (Ex. 1)-(Ex. 4) at −1° C. still exhibit the required minimum elasticity up to bursting of 15%. Applicability of the multilayer films disclosed in DE 10 2010 023 764 A1 thus is restricted to warmer times of the year or countries. Even at 20° C. the multilayer films disclosed in DE 10 2010 023 764 A1 are of limited suitability.

With the films of examples B1 to B8 in accordance with the invention much better mechanical values are obtained within the scope of a blow-up test. In all films in accordance with the invention splicing at −1° C. (and in particular at 20° C.) is much higher than in the films of V1 and V2. Moreover, in the films of B5 and B8, no splicing is noticeable at all, neither at low nor at higher temperatures. The films of examples B1, B2, B4, B5 and B6, up to a desired expansion of more than 15% when used as tubular inner films, hence do not exhibit splicing at all.

What is to be emphasized in particular in the films of examples B1 to B8 is an enormously improved elasticity up to bursting of the tubular film, which is influenced very little by the temperature. Thus, surprisingly all films in accordance with the invention exhibit an elasticity up to bursting of more or much more than 100%, both at −1° C. and at 20° C. Here, soft films, i.e. films of a low modulus of elasticity (confer below, lower than 200 MPa, preferably lower than 180 MPa) of examples B1 (expansion at −1° C. at 135.9%, expansion at 20° C. at 175.2%), B2 (expansion at −1° C. at 126.0%, expansion at 20° C. at 161.0%), B5 (expansion at −1° C. at 145.2%, expansion at 20° C. at 164.3%) and B6 (expansion at −1° C. at 134.3%, expansion at 20° C. at 153.8%) are distinguished particularly. In contrast to the previous standard films of comparative examples V1 and V2, the films of examples B1 to B8 in accordance with the invention at −1° C. exhibit an elasticity up to bursting of the hose of more than six times, while at 20° C. elasticity up to bursting on average was twice as high in the films of B1 to B8 in accordance with the invention. As a result it thus may be ascertained that the danger of bursting is eliminated in the films in accordance with the invention and that those films are particularly suited as tubular inner films for pipe lining constructions at all temperatures and in all kinds of weather.

As is shown by examples B7 and B8 as opposed to comparative examples V1 and V2, elasticity up to splicing or bursting of the film may be increased considerably if a polyamide mixture is used in which at least one polyamide has a low modulus of elasticity of lower than 500 MPa. In example B7, as opposed to comparative example V1, a polyamide with a modulus of elasticity of lower than 200 MPa or between 1 and 200 MPa was used instead of a homo polyamide with a modulus of elasticity of 2800. Although the polyamide with a modulus of elasticity of lower than 200 MPa or between 1 and 200 MPa is provided in the polyamide mixture merely by 12%, expansion up to splicing at −1° C. and 20° C. with values of 10.2 and 26.7% could be doubled or almost doubled. In addition, also elasticity up to bursting was clearly increased thereby (at −1° C. from 15.8% to 100.2%; at 20° C. from 80.5% to 127.9%).

A similar tendency also occurred in the films with a thickness of 120μ of comparative example V2 and example B8.

### Measurement of the Mechanical Properties of Modulus of Elasticity and Puncture Test

Within the scope of the present invention and in all embodiments of the present invention the modulus of elasticity and further tensile properties are measured in accordance with DIN EN ISO 527-1-3 with a test speed of 300 mm/min in machine direction (MD) and in transverse direction (TD). As testing device for the tensile tests the universal testing machine “Instron” is used for measuring the modulus of elasticity. Testing is performed on strips with a width of 15 mm that are clamped in a longitudinal direction between two grip sections of the testing machine, the distance of the two grip sections to each other being 100 mm and the strips of the film having been conditioned for 24 hours at 23° C. and a relative humidity of 50% prior to testing.

The puncture test is performed in accordance with JAS P 1019 with a test speed of 10 mm/min using the universal testing machine “Instron”, the film disk having a diameter of 50 mm and the needle having a diameter of 1 mm and a round tip with a diameter of 0.5 mm and the film disks having been conditioned for 24 hours at 23° C. and a relative humidity of 50% prior to testing.

The measuring values of the mechanical properties of the multilayer films of comparative examples V1 and V2 as well as of examples B1 and B8 are indicated in table 2. In the fourth column, the melting point of the polyamide respectively used (Mp. PA) is indicated in ° C. Tension moduli of elasticity (Young's moduli) and elongation at fracture were measured both in machine direction (MD) and transverse direction (“transverse direction” TD).

TABLE 1
Results of the measurement of mechanical properties

| | | | | Young's | | | |
|---|---|---|---|---|---|---|---|
| | | | | modulus | Elongation | Puncture | |
| | | Thickness | Mp PA | in MPa | at fracture | Force N/ | Deformation |
| Example | Structure | μ | in ° C. | MD/TD | % MD/TD | Power mJ | in mm |
| V1 | PA/PE/PE | 200 | 192 | 287/307 | 325/342 | 12.6/39.2 | 6.2 |
| V2 | PA/PE/PE | 120 | 192 | 275/279 | 364/374 | 7.9/27.2 | 6.7 |
| B1 | PA/PE/PE | 200 | 172 | 175/170 | 554/530 | 5.9/19.2 | 10.3 |
| B2 | PA/PE/PE | 120 | 172 | 170/173 | 502/500 | 5.5/18.2 | 11.9 |
| B3 | PA/PE/PE | 200 | 188 | 186/187 | 504/523 | 6.9/22.2 | 9.8 |
| B4 | PA/PE/PE | 200 | 203 | 182/181 | 499/501 | 7.7/23.7 | 9.0 |
| B5 | PA/PE | 200 | 173 | 140/141 | 566/572 | 6.9/17.6 | 13.2 |
| B6 | PA/PE | 120 | 173 | 124/124 | 637/639 | 5.6/19.8 | 14.9 |
| B7 | PA/PE | 200 | 173 and | 220/225 | 509/519 | — | — |
| | | | 192° C. | | | | |
| B7 | PA/PE | 120 | 173 and | 205/205 | 500/501 | — | — |
| | | | 192° C. | | | | |

The measurements of the mechanical values of the films of comparative examples V1 and V2 as well as examples B1 to B8 at 23° C. conform to the results of the blow-up test. The standard films of V1 and V2 have a very high modulus of elasticity of more than 250 MPa and do not include a polyamide with a modulus of elasticity of lower than 500 MPa. They exhibit an elongation at fracture of a maximum of 374% (V2, TD direction). In contrast thereto, all films of examples B1 to B8 in accordance with the invention are clearly softer and more flexible as the moduli of elasticity always are below 200 MPa, even below 150 MPa in B5 and B6. The moduli of elasticity of the films in accordance with examples B7 and B8 are slightly above 200 MPa (225 MPa at maximum). As is shown surprisingly by the mechanical values, the modulus of elasticity is the lower the higher the elongation at fracture. This was not to be expected. Thus, the films of examples B1 to B8 in accordance with the invention each exhibit elasticities in MD and TD direction of at least 500%, in the film with the lowest modulus of elasticity of example B6 elasticity even is clearly more than 600% for both testing directions. As is shown by the puncture test, the films of V1 and V2 are indeed more resistant vis-à-vis higher forces (in particular V1 with 12.6 N) than the films of B1 to B8 in accordance with the invention, but apparently this is not important in the use as tubular inner film because it has been shown that the films of B1 to B8 in accordance with the present invention on account of their high flexibility have much higher deformation than the films of V1 and V2. In the films of B5 and B6, the deformation is more than twice as high as that of the films of V1 and V2. Such behavior of the films in accordance with the invention has turned out to be particularly favorable, as the films of examples B1 to B8 may much better elude external load acting on the film and thus are less damaged by far, e.g. in assembly and installation of the pipe lining construction in a sewer to be rehabilitated. Apparently, the more flexible and better deformable film yields, whereas a less flexible, more rigid film is exposed to load, is less suited to elude it and in the end is damaged thereby.

Measurement of Abrasion Resistance

In accordance with the provisions of DIN EN 295, part 3, a hose section of a length of (1.000+/−10) mm and manufactured by blow film co-extrusion, which is sealed by lateral front plates, is filled with a sand-gravel-water mixture. The amount of testing material of 5.0 kg in accordance with DIN EN 295-3, table 3, is introduced into the hose section and subsequently filled with water up to a filling level of (38+/−2) mm. The hose section is alternately inclined by 22.5° in a longitudinal direction, so that abrasion on an inner side of the hose is caused by the movement of the testing material. Corresponding to the provisions, natural, unbroken, round-grain quartz gravel is used as testing material.

For determining surface removal the test is carried out over 300,000 alternations of load in total. Every 100,000 alternations of load the abrasion depth in mm is ascertained. The tipping operation is set to a frequency of about 20 alternations of load/minute.

Results of Measurements of Abrasion Resistance in Accordance with the Darmstadt Tipping Trough

The test results regarding abrasion resistance are listed in table 3.

TABLE 2
Results of the test of abrasion resistance in accordance
with the Darmstadt tipping trough

| | Abrasion behavior in accordance with DIN EN 295-3 |
|---|---|
| | (Darmstadt tipping trough, minimum alternation |
| Example | of load 100.000); abrasion depth in mm |
| V1 | 0.03 |
| V2 | 0.03 |
| B1 | 0.005 |
| B2 | 0.005 |
| B3 | 0.01 |
| B4 | 0.01 |
| B5 | 0.001 |
| B6 | 0.001 |
| B7 | 0.015 |
| B8 | 0.015 |

The trial for testing abrasion behavior in accordance with DIN 295-3 (Darmstadt tipping trough, minimum alternation of load 100,000) is carried out in order to determine whether a pipe lining construction withstands abrasion in a sewer. Abrasion is caused by water-solid-transport typical in a sewer system, mainly in the sole area of the sewer.

The method is indicated inter alia in the guidelines of the Deutsches Institut fir Bautechnik (DIBt) (German Institute for Structural Engineering), Berlin, for the selection and use of inner liners with plastic parts for mixed and sewage water sewers. The pipe lining constructions fulfill the requirements to abrasion resistance in accordance with the demands of the DIBt; excellent abrasion resistance was proved in the films of examples B1 to B6 in accordance with the invention with an abrasion depth of at most merely 0.01 mm after 100,000 alternations of load.

The measurements matter in case the tubular inner film after curing of the pipe lining construction remains in the sewer and particularly in case it forms an integral part of the pipe in the pipe.

As may be assumed on account of the properties of the multilayer films in accordance with the present invention that are to be seen from the mechanical measurements, harder films with a higher modulus of elasticity that are less flexible (V1 and V2) abrade much more than the films of examples B1 to B8 in accordance with the invention. The result is surprising, especially against the background that films of higher rigidity and a higher modulus of elasticity may be punctured and thus damaged only by a much higher force (V1 and V2) than more flexible, softer films with a lower modulus of elasticity (B1 to B8). Thus, the films of comparative examples 1 and 2 exhibit an abrasion depth of 0.03 mm each. Although this is a good value since it signifies only very little abrasion, the films of B1 and B2 merely have an abrasion depth of 0.005 mm, and the films of B5 and B6 even have an abrasion depth of only 0.001 mm (or 1μ) that falls below measurable abrasion. Thus the films in accordance with the invention are excellently suited as tubular inner films.

Tests in a freezer room held at −20° C. showed the following results:

TABLE 4
Results from the blow-up tests at −20° C.

| | Thickness in | | Elasticity |
|---|---|---|---|
| Example/ | μm | | [%] up to |
| Comparative | (Number of | Splicing [%] | bursting |
| example | layers) | −20° C. | −20° C. |
| V1 | 200 | 3.0 | Burst directly |
| | (5) | | after splicing |
| V2 | 120 | 3.3 | Burst directly |
| | (5) | | after splicing |
| B1 | 200 | 12.3 | 115.0 |
| | (5) | | |
| B2 | 120 | 10.4 | 109.7 |
| | (5) | | |
| B3 | 200 | 10.1 | 92.7 |
| | (5) | | |
| B4 | 200 | 15.8 | 101.4 |
| | (5) | | |
| B5 | 200 | No splicing | 125.1 |
| | (3) | | |
| B6 | 120 | No splicing | 127.2 |
| | (3) | | |
| B7 | 200 | 10.0 | 88.9 |
| | (5) | | |
| B8 | 120 | 10.2 | 87.3 |
| | (5) | | |
| (Ex. 1) | 140 | Not indicated | Not indicated |
| DE 10 2010 023 764 A1 | (5) | | |
| (Ex. 2) | 150 | Not indicated | Not indicated |
| DE 10 2010 023 764 A1 | (5) | | |
| (Ex. 3) | 140 | Not indicated | Not indicated |
| DE 10 2010 023 764 A1 | (5) | | |
| (Ex. 4) | 300 | Not indicated | Not indicated |
| DE 10 2010 023 764 A1 | (5) | | |

In the light of the foregoing, the multilayer film in accordance with the invention is perfectly suited as pipe liner for trenchless sewer rehabilitation even at very low outside temperatures, particularly at −20° C. From the experience made so far in such applications it may be concluded that even in a temperature range of −80° C. to 0° C. elasticities of 80 to 1000%, particularly 80 to 400% and preferably 80 to 200% may be achieved, the maximum elasticity in % being calculated from [(hose diameter after blow-up/initial hose diameter prior to blow-up)−1]×100.

1-15. (canceled)

16. A polymer tubular multilayer film that is at least in part translucent to electromagnetic radiation of a wavelength range of 150 to 600 nm and impermeable to organic volatile substances having a molecular mass of 20 to 300 gmol⁻¹ and includes at least one polyamide layer as well as at least one further layer of a different polymer material,
characterized in that
the multilayer film has a tension modulus of elasticity of 1 to 250 MPa or 1 to 500 MPa or 1 to 1000 MPa, measured in accordance with DIN EN ISO 527-1-3 with a test speed of 300 mm/min in machine direction (MD) and transverse direction (TD) after conditioning for 24 hours at 23° C. and a relative humidity of 50%, and
that the hose formed of the multilayer film in a radial direction and at a temperature of −40° C. to 0° C., in a blow-up test up to bursting, has an elasticity of between 80 to 400%, wherein the maximum elasticity in % is calculated from [(hose diameter after blow-up/initial hose diameter prior to blow-up)−1]×100, and wherein at least one polyamide of the at least one polyamide layer has a tension modulus of elasticity of 1 to 500 MPa, measured in accordance with DIN EN ISO 527-1-3 with a test speed of 300 mm/min in machine direction (MD) and transverse direction (TD) after conditioning for 24 hours at 23° C. and a relative humidity of 50%.

17. The multilayer film according to claim 16, characterized in that the organic volatile substances having a molecular mass of 20 to 300 gmol⁻¹ are selected from the group consisting of organic monomers, in particular styrene, divinylbenzene, ethene, ethyne, propylene and organic solvents, in particular ethanol, toluene, and acetone.

18. The multilayer film according to claim 16, characterized in that the at least one further layer includes a starting substance selected from the group consisting of: ethylene (meth) acrylate copolymer, thermoplastic olefin-homo- or copolymer, ethylene homo polymer (polyethylene, PE), polyethylene of low density (LDPE), LLDPE (linear low density polyethylene), polyethylene of high density (HDPE), PE (mPE) polymerized on the basis of metallocene catalysts, polypropylene homo polymers (polypropylene, PP), polypropylene random copolymers, butylene homo polymers (polybutylene, PB), isobutylene homo polymers (polyisobutylene, PI), ethylene vinyl alcohol copolymer (EVOH), polyvinyl alcohol (PVOH), cyclic olefin copolymer (COC), thermoplastic elastomers (TPE), particularly on the basis of PA elastomers, preferably PA 12 elastomers, block copolymers of PA12n segments and polyether segments or on a urethane basis (TPU) and a combination of two or more of the above-indicated starting substances.

19. The multilayer film according to claim 16, characterized in that at least one layer includes at least one additive that is selected from the group consisting of: antistatic agents, antioxidants, oxygen scavengers, antiblocking agents, anti-fog agents, antimicrobial agents, dyes, color pigments, stabilizers, preferably heat stabilizers, process stabilizers, process aids, flame retardants, nucleating agents, crystallizing agents, preferably crystal nucleating agents, lubricants, optical brighteners, flexibilization agents, sealing agents, softeners, silanes, spacers, fillers, peel-additives, waxes, wetting agents, surface active compounds, preferably tensides, UV stabilizers and disperging agents.

20. The multilayer film according to claim 16, characterized in that the multilayer film is formed as an inner hose of a pipe lining construction for trenchless sewer rehabilitation.

21. The multilayer film according to claim 16, characterized in that the polyamide layer includes a homo or copolyamide that is selected from the group consisting of: thermoplastic, aliphatic, partially aromatic or aromatic homo or copolyamides, in particular PA6, PA12, PA66, PA10, PA 11, PA 666, PA6I, PA 6,12, PA6T, PA elastomers, terpolyamides, quaterpolyamides, block copolymers of PA12 segments and polyether segments or a mixture of at least two of the above-indicated polyamides.

22. The multilayer film according to claim 16, characterized in that the thickness of the multilayer film is in a range of 10 to 4000 μm, preferably 40 to 2000 μm, particularly preferred from 60 to 1000 μm, in particular 80 to 400 μm, and the polyamide layer has a layer thickness of 1 μm to 200 μm, preferably between 5 and 100 μm, particularly preferred between 20 μm and 80 μm.

23. The multilayer film according to claim 20, wherein the multilayer film is a tubular inner film for pipe liners in trenchless sewer rehabilitation or as sliding film, preliner, reinforcing or calibration hose of pipe liners in trenchless sewer rehabilitation.

24. A pipe lining construction for trenchless sewer rehabilitation wherein a multilayer film includes an inner hose and a one layer or multilayer tubular film which absorbs UV radiation and/or visible light and further an outer hose located on the sewer side wall, wherein a carrier material impregnated with a reactive synthetic resin is provided between the inner hose and the outer hose.

25. The pipe lining of claim 24 is characterized in that in the inner hose formed of the multilayer film the at least one further layer is arranged at a radially inner side from the at least one polyamide layer and includes polypropylene (PP) as polymer material.

26. The pipe lining of claim 24 wherein the pipe lining rehabilitates a sewer section of a sewer for the transport of liquids, gases or solids, and is arranged so as to fit closely to the sewer wall in the direction of the liquids, gas or solids to be transported, and in which a carrier material is located between an inner hose and a hose lying on the side of the sewer wall, said carrier material including a cured synthetic resin.

27. The multilayer film according to claim 26, wherein the sewer section is characterized in that the multilayer film provided as tubular inner film remains in the rehabilitated sewer section.

28. The multilayer film according to claim 26, wherein the sewer section is characterized in that the multilayer film provided as tubular inner film is removed from the rehabilitated sewer section.
